(19) United States
(12) Patent Application Publication
(10) Pub. No.: US 2007/0133851 A1
(43) Pub. Date: Jun. 14, 2007

(54) Method and apparatus for selecting computer-assisted algorithms based on protocol and/or parameters of an acquisistion system

(75) Inventors: Saad Sirohey, Pewaukee, WI (US); Gopal B. Avinash, New Berlin, WI (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/301,856

(22) Filed: Dec. 12, 2005

(51) Int. Cl. G06K 9/00

(52) U.S. Cl. 382/128

(57) ABSTRACT

A system and method for selecting a computer algorithm for processing a medical image for a clinical purpose is enclosed. The method includes accessing image data, accessing clinical data, and accessing a structured knowledgebase. An optimal computer algorithm is selected with associated optimal operating parameters from a plurality of computer algorithms. The optimal computer algorithm may be selected based on the image data, the clinical data, and the structured knowledgebase information. The image data may be processed with the optimal computer algorithm. The structured knowledgebase may comprise a finite set of algorithms that span the possible algorithms for the clinical purpose. The image data may include meta data and anatomical information. The meta data may include modality information and image acquisition information. The computer algorithms may include computer algorithms for executing computer aided detection. The computer algorithms may also include computer algorithms for executing volume computer assisted reading.

### BACKGROUND OF THE INVENTION

The present invention generally relates to a system and method for improved workflow of a medical imaging system. Particularly, the present invention relates to a more efficient system and method for selecting an optimal computer algorithm for processing a medical image.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

An example of a medical diagnostic imaging system is Picture Archival Communication Systems (PACS). PACS is a term for equipment and software that permits images, such as x-rays, ultrasound, CT, MRI, EBT, MR, or nuclear medicine for example, to be electronically acquired, stored and transmitted for viewing. Images from an exam may be viewed immediately or stored, or transmitted. The images may be viewed on diagnostic workstations by users, for example radiologists. In addition to viewing the images, the user may also view patient information associated with the image for example the name of the patient or the patient's sex.

Many PACS systems run computer software for executing computer assisted detection and diagnosis tasks. In the execution of these tasks, the computer software generally relies on, for example, anatomical structures, clinical purpose, and function, among other variable. When operating the computer assisted detection and diagnosis software, a user may have to manually input these variables, making the process slow and inefficient. Also, the computer algorithms executing these tasks are fixed, meaning the software is not dynamic in receiving input.

The computer software may also rely on image acquisition protocols, including modality, reconstruction algorithms, and contrast agents, for example. As the computer assisted detection and diagnosis programs may rely on the image acquisition protocols, software programs written for a specific machine may not work on a different type of machine. For example, a computer algorithm designed for a four-slice CT scanner may not be applicable to a sixty-four slice CT scanner.

Currently, developers generally write unique software programs to generate results for numerous specific conditions. Developers designing algorithms to meet specific conditions generally account for most variations in the acquisition protocols. Typical variations may include reconstruction methods, noise in the data, temporal resolution, contrast employed, and other variables. Variables such as these are generally taken into account when developing the algorithms. As the number of variables increase, the level of complexity of the algorithm increases. Each of the variables generally introduces different complexities for automated or semi-automated computer assisted detection algorithms. Accordingly, utilizing unique algorithms for specific conditions is generally inefficient and prohibitively expensive for development and commercialization.

Accordingly, a need exists for a system and method that may be utilized to optimally select a computer algorithm, or path of algorithms, based on input. Such a system and method may provide a solution for optimally executing computer assisted detection and diagnosis tasks.

### SUMMARY OF THE INVENTION

Certain embodiments of the present invention may include a method for selecting a computer algorithm for processing a medical image for a clinical purpose is enclosed. The method may include accessing image data, accessing clinical data, and accessing a structured knowledgebase. An optimal computer algorithm is selected with associated optimal operating parameters from a plurality of computer algorithms. The optimal computer algorithm may be selected based on the image data, the clinical data, and the structured knowledgebase information. The image data may be processed with the optimal computer algorithm. The optimal computer algorithm may include multiple computer algorithms. The structured knowledgebase may comprise a finite set of algorithms that span the possible algorithms for the clinical purpose. The image data may include meta data and anatomical information. The meta data may include modality information and image acquisition information. The computer algorithms may include computer algorithms for executing computer aided detection. The computer algorithms may also include computer algorithms for executing volume computer assisted reading.

Certain embodiments of the present invention may include a system for selecting a computer algorithm for processing a medical image for a clinical purpose. The system may include a computer unit for manipulating data. The computer unit may execute computer software for accessing image data and accessing clinical data and accessing a structured knowledgebase. The computer software selects an optimal computer algorithm with associated optimal operating parameters from a plurality of computer algorithms. The optimal computer algorithm may be selected based on the image data and the clinical data and structured knowledgebase information The computer software processes the image data with the optimal computer algorithm. The system may also include an input unit for receiving input from a user and a display unit for displaying information to a user.

The structured knowledgebase may comprises a finite set of algorithms that span the possible algorithms for the clinical purpose. The image data may include anatomical information and meta data. The meta data may include image acquisition information and modality information. Additionally, the optimal computer algorithm may include multiple computer algorithms. The plurality of computer algorithms may include computer algorithms for executing computer aided detection. Moreover, the plurality of computer algorithms may include computer algorithms for executing volume computer assisted reading. The computer unit, input unit, and display unit may comprise a picture archival communication system.

Certain embodiments of the present invention may be carried out as part of a computer—readable storage medium including a set of instructions for a computer. The set of instructions may include a first accessing routine for accessing image data, a second accessing routine for accessing clinical data, and a third accessing routine for accessing a structured knowledgebase. The set of instructions may also include a selection routine for selecting an optimal computer algorithm with associated optimal operating parameters from a plurality of computer algorithms. The optimal computer algorithm may be selected based on the image data, the clinical data, and the structured knowledgebase information. The set of instructions may also include a processing routine for processing said image data with said optimal computer algorithm.

### BRIEF DESCRIPTION OF THE DRAWINGS

FIG. 1 illustrates an example of a system that may be used in accordance with an embodiment of the present invention.

FIG. 2 illustrate a method that may be used in accordance with an embodiment of the present invention.

FIG. 3 illustrates an example a knowledgebase that may be used in accordance with an embodiment of the present invention.

FIG. 4 illustrates a general depiction of selecting the optimal piecewise linear stratification of algorithm paths in accordance with an embodiment of the present invention.

FIG. 5 illustrates an example of selecting the optimal piecewise linear stratification of algorithm paths in accordance with an embodiment of the present invention.

FIG. 6 illustrates an example of the method of FIG. 2 with volume computer assisted reading and with computer aided detection.

### DETAILED DESCRIPTION OF THE INVENTION

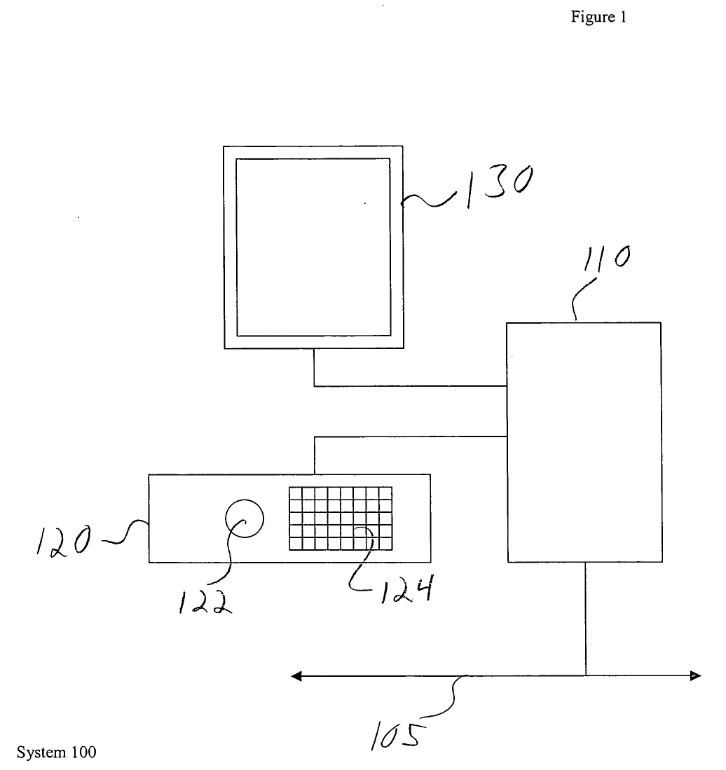

FIG. 1 illustrates a system 100 for manipulating and displaying medical images. The system 100 includes a computer unit 110. The computer unit 110 may be any equipment or software that permits electronic medical images, such as x-rays, ultrasound, CT, MRI, EBT, MR, or nuclear medicine for example, to be electronically acquired, stored, or transmitted for viewing and operation. The computer unit 110 may receive input from a user. The computer unit 110 may be connected to other devices as part of an electronic network. In FIG. 1, the connection to the network is represented by line 105. The computer unit 110 may be connected to network 105 physically, by a wire, or through a wireless medium. In an embodiment, the computer unit 110 may be, or may be part of, a picture archival communication system (PACS).

The system 100 also includes an input unit 120. The input unit 120 may be a console having a track ball 122 and keyboard 124. Other input devices may be used to receive input from a user as part of the input unit 120. For example a microphone may be used to receive verbal input from a user. The system 100 also includes at least one display unit 130. The display unit 130 may be a typical computer display unit. The display unit 130 may be in electrical communication with the computer unit 110 and input unit 120. In an embodiment, the display unit 130 may represent multiple display units or display regions of a screen. Accordingly, any number of display units may be utilized in accordance with the present invention.

In an embodiment, the system 100 is a PACS with display unit 130 representing the display unit of PACS. The computer unit 110 may represent equipment and components of a PACS system other than the display unit. The computer unit 110 and display unit 130 may be separate units or be part of a single unit. In the case of separate units, the display unit 130 may be in electrical communication with the computer unit 110. The components of the system 100 may be single units, separate units, may be integrated in various forms, and may be implemented in hardware and/or in software.

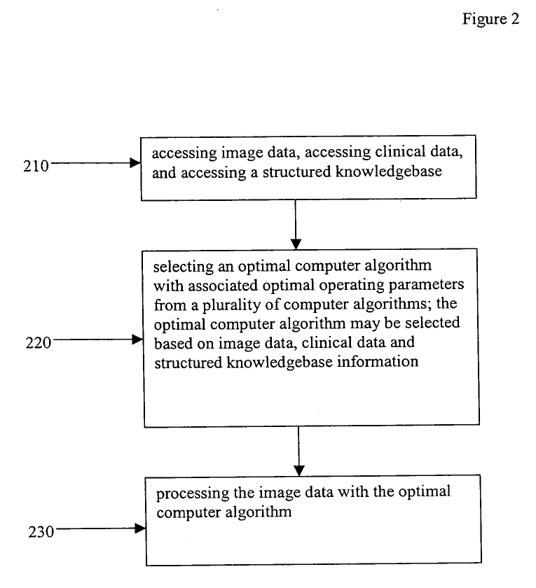

FIG. 2 illustrates a method 200 for selecting a computer algorithm for processing a medical image. A medical image may be processed by image processing algorithms for enhancement, detection, quantification, or segmentation, for example. The method 200 may be executed by computer software residing on computer unit 110. Alternatively, the method 200 may be executed by computer software on a computer system, such as a server or database, different from where the computer software is stored. In another alternative, the computer software may be executed and stored external to the computer unit 110. The computer unit 110, however, may be in communication with the computer system or server executing and/or storing the computer software for the method 200 via the network 105. In an embodiment, the computer software executing the method 200 may be referred to as a rules engine herein.

The method 200 may be utilized to select a computer algorithm to process a medical image. A computer algorithm may include one or more computer programs. For example, the method 200 may be used to select a computer algorithm to achieve a clinical purpose. In an embodiment, the clinical purpose may be to perform nodule sizing for a lung. The method 200 may select a computer algorithm based on values of several inputs, in order to achieve the goal of nodule sizing for the lung. The method 200 allows the clinical purpose to be achieved by selecting the optimal algorithm based on image data, clinical data, and structured knowledgebase information. The image data may include the image of the anatomy and associated parameters as well as image meta-data. The image meta-data may include image acquisition information, such as, for example, modality and slice thickness. The clinical data may include clinical purpose information, for example, task information such as an examination to determine whether a patient has cancer in the lung. Based on the image data and clinical data, an optimal computer algorithm may be selected to achieve the clinical purpose. The optimal computer algorithm may be selected from a structured knowledgebase having structured knowledgebase information. A structured knowledgebase may be a database or server having information to select the optimal computer algorithm to achieve a given clinical purpose based on the input. Once the optimal computer algorithm is selected, the image data may be processed by the optimal computer algorithm with the associated parameters.

At step 210, the computer software accesses data. Specifically, the computer software accesses image data, clinical data, and a structured knowledgebase for knowledgebase information. The image data may include the image of the anatomy and associated parameters as well as image meta-data. The image meta-data may include image acquisition information, such as, for example, modality information, slice thickness, dose, reconstruction kernel, pulse sequences, T1/T2 weighting, TE/TR weighting, for example. The clinical data may include clinical purpose information, for example, body parts, disease type, tracers used, screening, follow-up, diagnostic rule out, or differential diagnostic information. Both the clinical data and image data may reside on computer unit 110 and may be accessed accordingly by the computer software executing the method 200. Alternatively the clinical and image data may reside on a different computer unit, or different computer units, systems, databases, servers, or other storage or processing device and be accessed accordingly.

After the image data and clinical data are accessed, a structured knowledgebase is accessed. With the image data and clinical data as inputs, the structured knowledgebase may be used to select the an optimal computer algorithm, as in step 220. A structured knowledgebase may be a database or server comprising a finite set of algorithms that span the possible algorithms for the clinical purpose. For example, the structured knowledgebase may be information about which computer algorithms are optimal to achieve a clinical task given a set of data and parameters. The structured knowledgebase information may be stored as part of computer unit 110, or may be stored in an external location, such as database, and connected to computer unit 110 via network 105.

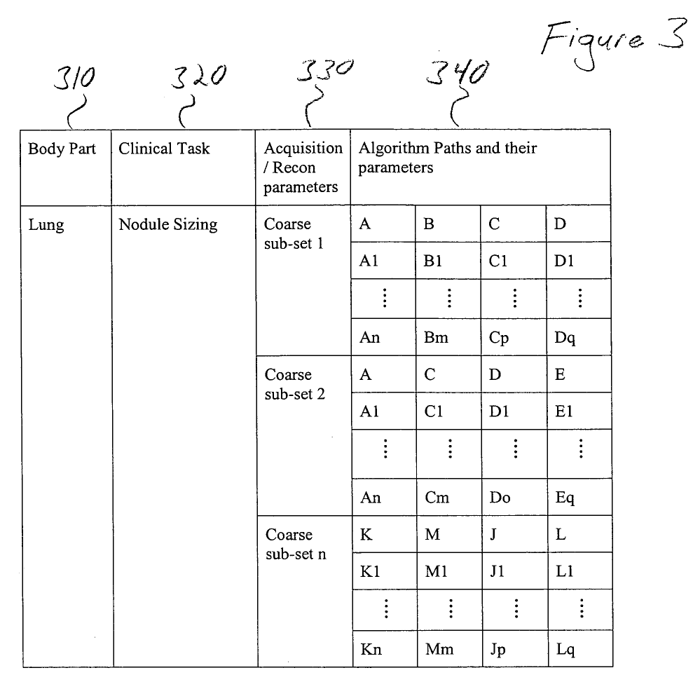

FIG. 3 illustrates an example of the fields that may be available in an example structured knowledgebase. Column 310 identifies a given body part. Column 320 identifies a given clinical task for the body part identified in column 310. Column 330 illustrates a plurality of piecewise linear sets. These sets include a range of acquisition parameters that have similar characteristics from a processing point of view.

Column 340 illustrates optimal computer algorithms for a given set of parameters. In an embodiment, depending on the parameters, a coarse sub-set may be selected, such as coarse sub-set 1, coarse sub-set 2, through coarse sub-set n. The coarse sub-sets identify different computer algorithms that may be executed to achieve the clinical purpose based on the image data and clinical data.

For the example shown in FIG. 3, the body part identified is the lung. If a user wishes to perform nodule sizing on the lung (i.e. the clinical purpose is to perform nodule sizing on the lung), various coarse sub-sets are identified. For example, coarse sub-set 1 through coarse sub-set n are shown in FIG. 3. Any number of coarse sub-sets may be used. A coarse sub-set may be selected based on the imaging data, for example the acquisition/reconstruction parameters. Each coarse sub-set has an computer algorithm that may be executed to achieve the clinical purpose. For example, if the acquisition/reconstruction parameters indicate that coarse sub-set 1 is optimal, algorithms A, B, C, or D may be selected. If coarse sub-set 2 is optimal, then algorithms A, C, D, or E may be selected. The selection of the algorithms may be determined by the image data and the clinical data. Continuing with the example, if the data and parameters indicate that the optimal algorithms to perform nodule sizing for a specific lung is path E in coarse sub-set 2, then coarse sub-set 2, algorithm E may be selected.

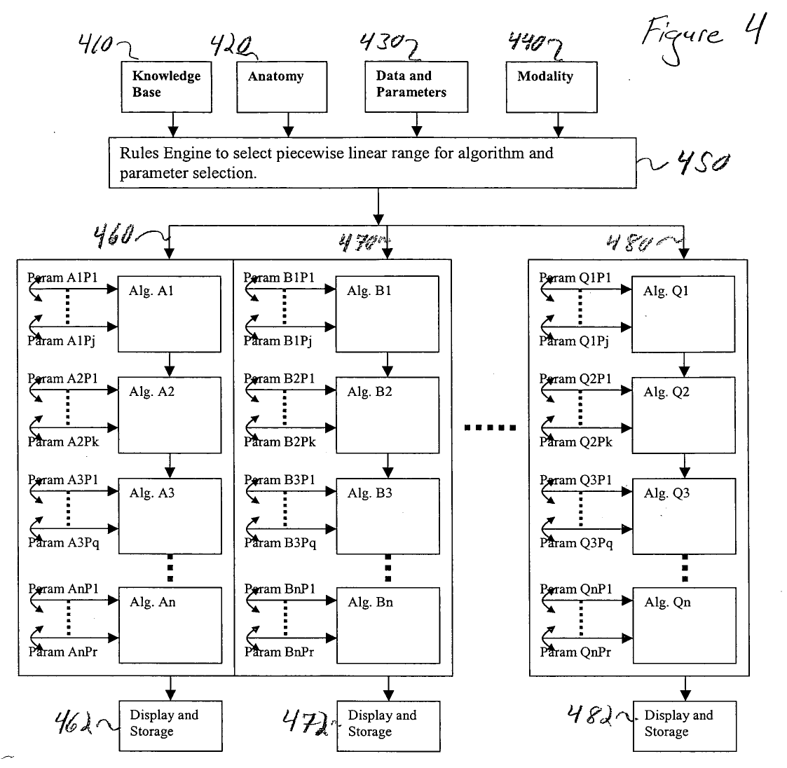

FIG. 4 illustrates a general depiction of selecting the optimal piecewise linear stratification of a computer algorithm. Block 410 represents the structured knowledgebase information. Block 420 represents imaging data, such as anatomy. Block 430 represents imaging and clinical data, such as image meta-data and clinical purpose. Block 440 represents imaging data, such as modality information.

The rules engine 450 represents the computer software program executed as method 200. In the embodiment shown in FIG. 4, the rules engine 450 accesses image data 420-440 and clinical data 430. Based on this data 420-440 and information from the structured knowledgebase 410, the rules engine 450 selects an optimal computer algorithm from a plurality of computer algorithms 460-480. For example, the rules engine 450 may select computer algorithms 460, 470, or 480. As further discussed below, once the optimal computer algorithm is selected, the algorithm may be executed and the results may be displayed and/or stored as shown in blocks 462, 472, and 482.

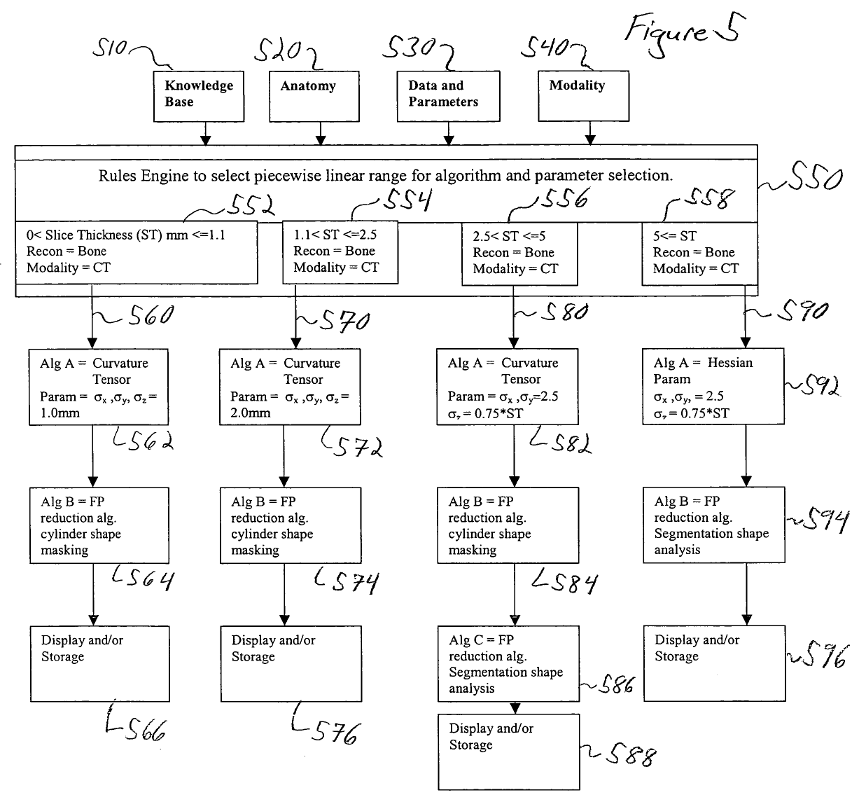

After the optimal computer algorithm is selected, step 230 of the method 200 includes processing the image data with the optimal computer algorithm. FIG. 5 illustrates the step 230 of processing the image data with the optimal computer algorithm. FIG. 5 has similar inputs as FIG. 4, as Block 510 represents the structured knowledgebase information. Block 520 represents imaging data, such as anatomy. Block 530 represents imaging and clinical data, such as image meta-data and clinical purpose. Block 540 represents imaging data, such as modality information. Block 550 represents a rules engine, similar to block 450 in FIG. 4.

Within the rules engine block 550, however, blocks 552, 554, 556, and 558 represent conditions to select a computer algorithm, 560, 570, 580, or 590 and assign parameters. The conditions may be selected based on the inputs 510-540. In the example shown, the conditions in blocks 552-558 are slice thickness, reconstruction type, and modality. For blocks 552-558, the reconstruction type is bone and the modality is CT. In the example provided, these two factors have narrowed the possible computer algorithms to four, 560-590. The differing factor in the selection of the algorithms is the slice thickness. As shown in FIG. 5, for a slice thickness of less then 1.1 mm in block 552, algorithm 560 is chosen. For a slice thickness between 1.1 mm and 2.5 mm in block 554, algorithm 554 is chosen. For a slice thickness between 2.5 mm and 5 mm in block 556, algorithm 580 is chosen. For slice thickness greater than 5 mm in block 558, algorithm 590 is chosen.

In addition to selecting the optimal computer algorithm, the rules engine 550 then assigns the associated parameters, as in step 230. If algorithm 560 is selected, a Curvature Tensor algorithm is selected and various parameters are assigned to 1.0 mm in block 562. At block 564, a false positive reduction is performed and at block 566, the results may be executed and displayed and/or stored. If algorithm 570 is selected by the rules engine 550, a Curvature Tensor algorithm is performed and parameters are assigned to 2.0 mm in block 572. Similar to algorithm 560, a false positive reduction is performed at block 574 and at block 576 results are executed and displayed and/or stored.

If algorithm 580 is chosen, a Curvature Tensor algorithm is chosen as in algorithm 560 and 570, however, now parameters are assigned differently as is shown in block 582. A false positive reduction is performed in block 584, and again in block 586. The results may be executed and displayed and/or stored in block 588. If path 590 is chosen, a different algorithm is selected from paths 560-580. A Hessian algorithm is chosen and parameters are assigned accordingly at block 592. At block 594, a false positive reduction is performed and at block 596 the results are executed and ready for display and/or storage.

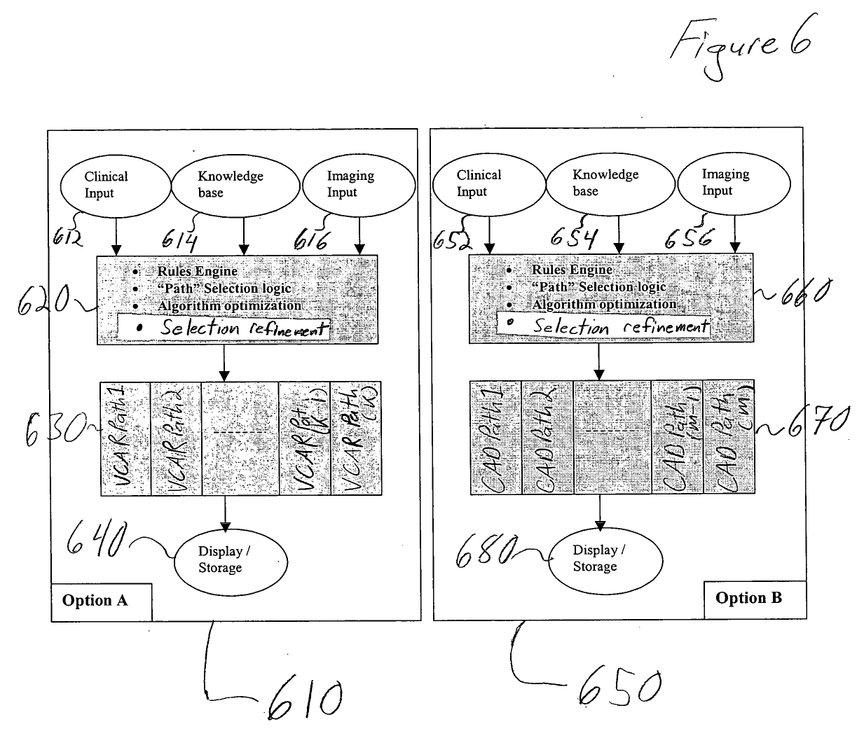

FIG. 6 illustrates an embodiment of the present invention. Specifically, FIG. 6 illustrates a schematic of a high-level diagram of the algorithm selection process with volume computer assisted reading, option A 610, and with computer aided detection option B 650. Both options A 610 and B 650 have three inputs, similar to the inputs discussed above. Input 612, 652 represents the clinical data, input 614, 654 represents the structured knowledgebase input, and inputs 616, 618 represent the imaging data. The inputs are directed to a rules engine, 620, 660. The rules engines 620, 660 are similar in function to rules engines to 450, 550 in FIGS. 4 and 5, respectively. The rules engines 620, 660 access the data 612, 614, 616 and data 652, 654, 658, respectively. The rules engines 620, 660 select the optimal computer algorithm based on the image data, the clinical data, and the knowledgebase information. The rules engines 620, 660 also assign the correct parameters to the selected algorithm based on the data. Additionally, as shown in blocks 620, 660, the rules engine may perform parameter selection.

Blocks 630 and 670 represent the different algorithmic paths that may be selected. The blocks 630 and 670 correspond to 460-480 of FIG. 4, and 660-690 of FIG. 5. The block 630 represents a plurality of computer algorithms that may be utilized to perform volume computer assisted reading. As shown in the block 630, the paths may include VCAR Path 1-VCAR Path K. The block 670 represents a plurality of computer algorithms that may be utilized to perform computer aided detection. As shown in the block 670, the paths may include CAD Path 1-CAD Path M. Which paths are chosen from blocks 630 or 670 may be based on the data 612-616 for the block of possible paths for VCAR 630 or data 652-656 for the block of possible paths for CAD 670. As illustrated in blocks 640 and 680, once the algorithm has been selected and executed, the results may be displayed and/or stored.

The system and method described above may be carried out as part of a computer-readable storage medium including a set of instructions for a computer. The set of instructions may include a first accessing routine for accessing image data, a second accessing routine for accessing clinical data, and a third accessing routine for accessing a structured knowledgebase. The set of instructions may also include a selection routine for selecting an optimal computer algorithm with associated optimal operating parameters from a plurality of computer algorithms. The optimal computer algorithm may be selected based on the image data, the clinical data, and the structured knowledgebase information. The set of instructions may also include a processing routine for processing said image data with said optimal computer algorithm.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for selecting a computer algorithm for processing a medical image for a clinical purpose, said method comprising:
accessing image data;
accessing clinical data;
accessing a structured knowledgebase;
selecting an optimal computer algorithm with associated optimal operating parameters from a plurality of computer algorithms, said optimal computer algorithm being selected based on said image data and said clinical data and structured knowledgebase information; and
processing said image data with said optimal computer algorithm.

2. The method of claim 1 wherein the structured knowledgebase comprises a finite set of algorithms that span the possible algorithms for the clinical purpose.

3. The method of claim 1, wherein said image data includes anatomical information.

4. The method of claim 1, wherein said image data includes meta data.

5. The method of claim 3, wherein said meta data includes modality information.

6. The method of claim 3, wherein said meta data includes image acquisition information.

7. The method of claim 1, wherein said optimal computer algorithm includes multiple computer algorithms.

8. The method of claim 1, wherein said plurality of computer algorithms includes computer algorithms for executing computer aided detection.

9. The method of claim 1, wherein said plurality of computer algorithms includes computer algorithms for executing volume computer assisted reading.

10. A system for selecting a computer algorithm for processing a medical image for a clinical purpose, said system comprising:
a computer unit for manipulating data, said computer unit executing computer software for accessing image data and accessing clinical data and accessing a structured knowledgebase, said computer software selects an optimal computer algorithm with associated optimal operating parameters from a plurality of computer algorithms, said optimal computer algorithm being selected based on said image data and said clinical data and structured knowledgebase information, and said computer software processes said image data with said optimal computer algorithm.
an input unit for receiving input from a user; and
a display unit for displaying information to a user.

11. The system of claim 10, wherein said structured knowledgebase comprises a finite set of algorithms that span the possible algorithms for the clinical purpose.

12. The system of claim 10, wherein said image data includes anatomical information.

13. The system of claim 10, wherein said image data includes meta data.

14. The system of claim 13, wherein said meta data includes image acquisition information.

15. The system of claim 13, wherein said meta data includes modality information.

16. The system of claim 10, wherein said optimal computer algorithm includes multiple computer algorithms.

17. The system of claim 10, wherein said plurality of computer algorithms includes computer algorithms for executing computer aided detection.

18. The system of claim 10, wherein said plurality of computer algorithms includes computer algorithms for executing volume computer assisted reading.

19. The system of claim 10, wherein said computer unit, input unit, and display unit comprise a picture archival communication system.

20. A computer-readable storage medium including a set of instructions for a computer, the set of instructions comprising:
a first accessing routine for accessing image data;
a second accessing routine for accessing clinical data;
a third accessing routine for accessing a structured knowledgebase;
a selection routine for selecting an optimal computer algorithm with associated optimal operating parameters from a plurality of computer algorithms, said optimal computer algorithm being selected based on said image data and said clinical data and structured knowledgebase information; and
a processing routine for processing said image data with said optimal computer algorithm.
